(19) United States
(12) Patent Application Publication
(10) Pub. No.: US 2010/0017239 A1
(43) Pub. Date: Jan. 21, 2010

(54) Forecasting Discovery Costs Using Historic Data

(76) Inventors: Eric Saltzman, Menlo Park, CA (US); Deidre Paknad, Palo Alto, CA (US); Roman Kisin, San Jose, CA (US); Pierre Raynaud-Richard, Redwood City, CA (US)

Correspondence Address: GLENN PATENT GROUP, 3475 EDISON WAY, SUITE L, MENLO PARK, CA, 94025, US

(21) Appl. No.: 12/165,018

(22) Filed: Jun. 30, 2008

(51) Int. Cl. G06Q 10/00; G06Q 50/00

(52) U.S. Cl. 705/7

(57) ABSTRACT

A computer-implemented method and apparatus for forecasting discovery costs includes probability-based forecasting and capturing historic stage transition data for each matter stage regarding the duration of each historic matter stage and regarding the number of new custodians and data sources added during that matter stage. The stage transition data is statistically and aggregated by stage and matter type. Progress for existing matters is extrapolated. Initiation of future matters is forecast by extrapolating how many new matters are expected to be initiated over the duration of a forecasting period. The average pace of progress is extrapolated from the historic data. Volumes of production and custodians are forecasted by extrapolation using quantitative characteristics of the historic stage transition data.

### BACKGROUND OF THE INVENTION

1. Field of the Invention

This invention relates to method and apparatus for forecasting litigation discovery costs by collecting and analyzing historic data to predict future costs and timing.

2. Prior Art

Because of the increasing cost of litigation discovery, litigation expenses are increasing in both absolute dollars and as a percentage of operating budgets for some companies. It is difficult to predict discovery costs on a matter-by-matter basis because the outcome of any individual litigation matter cannot be accurately predicted. The amount of and timing of discovery expenses can have a material impact on a company's operating results.

Previously, forecasting methods for E*Discovery costs were very ad hoc and manual. Only limited data could be leveraged as people had no effective mean to collect and mine historical data, and no effective way to track detailed recent activity on current matters. As a result, forecasts were done using empirical forecasting methods, based more often on perception of cost trends rather than on real data, using simple models implemented using manual spreadsheet formulas. Consistency and accuracy was extremely low. As a result, such forecasts were not relied upon for budgeting purposes. Instead, budgets were developed using simple year-to-year trends combined with intuitive guesses.

Given current litigation volume in large corporations, the number of people possessing information related to each matter in litigation, and the widespread use of third party contractors to provide discovery services, it is difficult to develop and maintain accurate cost forecasts without a dedicated cost-forecasting tool. Providing a methodology and automated process for predicting discovery costs enables companies to accurately forecast their expenses.

### SUMMARY OF THE INVENTION

Future discovery costs are predicted using historic data to provide probability based forecasting. In-house legal teams possess a wealth of information regarding historic costs of discovery. A software solution can analyze this historic information to determine the expected outcome of current and future litigation matters and to predict discovery costs. The present invention provides a “litigation funnel” that predicts both fall out at defined stages of a litigation matter and that also predicts the discovery cost incurred at each stage of the litigation.

The present invention provides a method and apparatus for forecasting discovery costs. The method includes capturing historic stage transition data for each matter stage that information regarding the duration of each historic matter stage and regarding the number of new custodians and data sources added during that matter stage. The method also includes: statistically analyzing the stage transition data for each existing matter stage and aggregating existing stage transition data for each matter type; extrapolating progress for existing matters; forecasting initiation of future matters by extrapolating how many new matters are expected to be initiated over the duration of a forecasting period; extrapolating the average pace of progress that the future matters are expected to experience within the forecasting period; and forecasting the volume of production by extrapolation using quantitative characteristics of said historic stage transition data.

Another computer-implemented method is provided for forecasting litigation discovery costs using historic data for each stage of existing litigation matters. The method includes providing historic data for the duration of each stage of existing matters; calculating historic statistical information from said historic data; aggregating the historic statistical information by matter type; calculating probability distributions for reaching production stages for each matter type from the historic statistical information; extrapolating future progress for each type of existing matter using the historic statistical information; extrapolating how many new matters will be created using the historical statistical information; extrapolating an average pace of progresses for each of the new matters during the forecasted future time periods using the historic statistical information; and forecasting the volumes of production using the number of custodians and data sources.

Another computer implemented method for forecasting litigation discovery costs using historic data and probability-based forecasting includes the steps of: capturing stage transition data, which includes information on the duration of each matter stage and the number of new custodians and data sources added during a given stage; analyzing and aggregating by matter type the captured transition data to provide statistical information; extrapolating progress on known existing matters using the statistical information; and forecasting how many new matters are likely to be created over the duration of a forecast period and extrapolating the average pace of progress that matters are likely to go through within the forecast period. The method of claim 3 includes forecasting the volumes of production based on the historic data and forecasting discovery costs by applying a culling rate and average review cost. The data for each matter stage is analyzed and aggregated by matter type in one or more of the following: mean duration of the stages, standard deviation of the duration of the stages, added custodians, standard deviation of added custodians, added data sources, standard deviation of added data sources, gigabytes collected per custodian, gigabytes collected per data source, and fallout rate percent. The method also includes using statistical data for calculating probability distributions for reaching a production stage for existing matters, extrapolating progress on existing matters, and extrapolating with exponential smoothing.

A system for forecasting litigation discovery costs using historic data and probability-based forecasting includes a forecasting database; and a forecasting module including a raw data analysis and aggregation module and an existing matter forecasting module. The system includes a future matter forecasting module that extrapolates progress for known existing matters. The system further includes a cost modeling module that uses an extrapolated collection volume along with a culling rate and average estimated review costs.

The system further includes a trend analysis module that analyzes historical data to determine if longer term trends occur and if seasonal or cyclical patterns occur, an event correlation analysis module that analyzes patterns of litigation events, an error tracking module for costs that compares forecasted cost to actual costs and makes appropriate changes to calibrate the forecasting module with historical data, and a 3^{rd} party system module that provides to the forecasting model outside information, including matter management information, billing information, and other external data.

The system also includes a model calibration tools module that provides calibration tools for tuning model variables and a reporting module that receives information from the forecasting module and provides reports to users.

An automated system for forecasting litigation discovery costs using historic data and probability-based forecasting is provided to include a forecasting data base; a forecasting module including a raw data analysis and aggregation module, an existing matter forecasting module; a litigation database that provides relevant data to an automated data collection module; and a reporting module that receives information from the forecasting module and provides reports to users. The automated system also includes a 3^{rd} party system module that provides to the forecasting model outside information, including matter management information, billing information, and other external data, and a model calibration tools module that provides calibration tools for tuning model variables.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a flow diagram illustrating a computer-implemented method for forecasting discovery costs using historic data.

FIG. 2 is an illustrative timing chart showing actual historical information for eight existing legal matters over two past quarters.

FIG. 3 is an illustrative timing chart extrapolated progress for six active matters of FIG. 3 at the beginning of a new quarter.

FIG. 4 is another illustrative timing chart that includes the active matters of FIG. 3 and that also includes three forecasted new matters beginning now and three other new matters beginning in the next quarter.

FIG. 5 illustrates a data entry screen for a user interface that enables a user to manually adjust major parameters of a prediction model.

FIG. 6 illustrates another data entry screen for a user interface that enables a user to manually adjust parameters of an individual matter

FIG. 7 is a bar chart illustrating the cost by quarter for four different types of matters.

FIG. 8 is a pie chart illustrating a yearly estimate of discovery costs for the four different types of matters illustrated in FIG. 7.

FIG. 9 is a pie chart illustrating the yearly distribution of quarterly expenses.

### DETAILED DESCRIPTION OF THE PREFERRED EMBODIMENTS

Reference is now made in detail to preferred embodiments of the invention, examples of which are illustrated in the accompanying drawings. While the invention is described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims.

The present invention uses historic data and probability based forecasting to forecast future discovery timing and costs. The present invention automates the process of collecting and statistically analyzing historic data on litigation to predict future outcomes and costs. The present invention can provide pre-configured reports on projected discovery costs. The present invention provides for collection of data from multiple software applications to enable analysis of various variables necessary to forecast discovery expense.

One key to development of a successful litigation cost forecasting tool is identification of relevant variables and application of those variables to a comprehensive data set. Some key variables for forecasting future discovery costs include:

Regarding various different matter types, monitoring historic data by specific legal matter types provides far better predictability than by monitoring data across all of the different matter types. Litigation matters move through different stages. One illustrative example, described herein below, provides six stages that a matter moves through. The percentage of matters, or litigation cases, that move from stage to stage, the time spent at each stage, and the amount of data collected and produced varies considerably by matter type. For example, the typical chronology and discovery cost for different matters, such as, for example, a wrongful termination case, a patent infringement claim, or a securities class action, are all very different.

Within each matter type, the effective cost predictability model can analyze the following data: The Average Number of New Matters per Quarter by Matter Type describes how many potential claims arise each quarter, corresponding to Stage 1, that is, Notice of Potential Claims. The Average Number of Custodians describes how many individuals possess data potentially relevant to a particular matter. The Average Number of Data Sources describes how many data sources contain data potentially relevant to the particular matter. The Average Amount of Data Collected per Custodian describes, for those matters that advance to a stage at which collection is required, how much data is collected per custodian. The Average Amount of Data Collected per Data Source describes, for those matters that advance to the stage at which collection is required, how much data is collected per data source. The Average Amount of Pages per Megabyte of Data Collected describes how many pages of data are produced per megabyte of data collected. The Average Cull Rate describes what percentage of pages collected is eliminated as duplicate or irrelevant. The Average Review Rate describes the number of pages per hour that an attorney can review, using automated review tools as applicable. The Average Review Cost describes the hourly rate for attorney review. The Average Time from Each Stage of the Litigation Funnel to Production of Documents describes how much time elapses from the time the complaint is filed to the first and subsequent production of documents. Unlike the other variables, this variable predicts the time when the expenses hit, not the amount of the expenses.

The invention provides the ability to extract and analyze historical data pertaining to the legal matters and then forecast future discovery costs. Historical data is gathered from a litigation database using automated methods. The data is gathered into a forecasting database where it goes through multiple processing steps including aggregation and statistical refinement. Legal matters of a given matter type tend to have similar characteristics and the present inventive method groups the gathered data by matter type. This is then followed by a modeling step where the processed data is fed into a quantitative forecasting model. The model is based on the concept of litigation stages for a matter and takes into account the probability of reaching an export stage where the majority of the discovery costs are incurred. An illustrative example of the different stages that a legal matter goes through includes the following six stages: (1) a Notice is filed of potential claim; (2) a Complaint is filed and served; (3) Interrogatories and Discovery Requests are served; (4) a First Meet and Confer Conference is held; (5) a First Production of documents is made; and (6) a Second Document Request with collection plan is made.

The quantitative forecasting model is capable of recognizing various trends in patterns of historical data and of adjusting the forecast accordingly. The quantitative forecasting modeling includes several steps, which include extrapolating how many new legal matters are likely to be created and in which stage existing and future matters are likely to end up at the end of a forecasting period. The next modeling step involves extrapolating the quantitative characteristics of the collection scope for those matters that are likely to reach the production stage. The next step involves calculating the expected export volumes based on the average amount of data collected per person/data source for a given matter type and based on the extrapolated number of persons and data sources for the qualified matters. Future discovery costs are derived from the extrapolated collection volume using a culling rate and an average review cost.

The invention provides a computer-implemented method that provides reliable forecasting of discovery costs. The invention uses a set of technologies that provide a high level of forecasting accuracy, while maintaining simplicity and ease of use. A forecast engine (FE) is thus provided, which uses historical data as the basis for estimating and forecasting future discovery costs. The methods used for forecasting discovery costs forecasting uses statistical sources that make forecasts based on statistical patterns in the data from historical litigation events and their correlation in time.

Forecasting Engine Overview

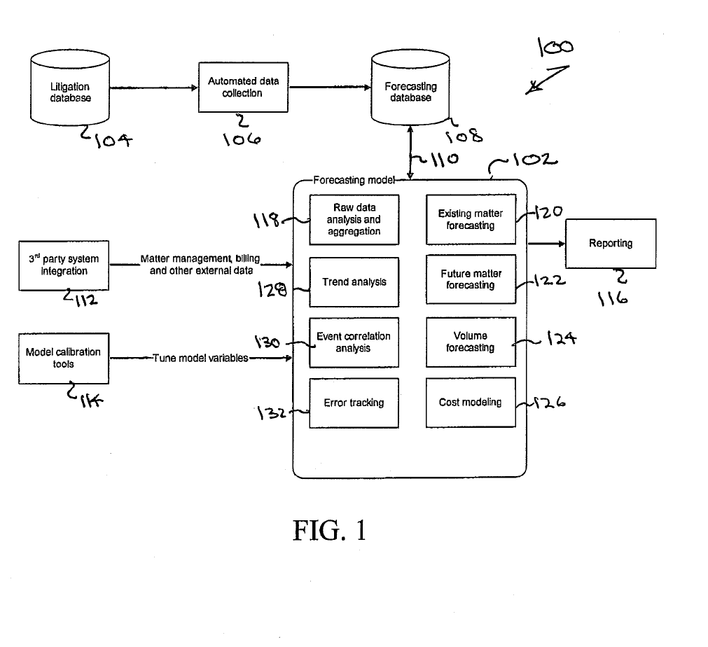

FIG. 1 is a high level flow diagram 100 that provides an overview of a forecasting model, or forecasting engine (FE), 102. Various modules provide a computer-implemented method for forecasting discovery costs using historic data. A litigation database 104 provides relevant data to an automated data collection module 106. A forecasting database 108 receives input from the automated data collection module 106. The forecasting data base 108 also has an input/output (I/O) port 100 that communicates with the forecasting module 102. A 3^{rd} party system module 112 provides to the forecasting model 102 outside information, including matter management information, billing information, and other external data, as required. A model calibration tools module 114 provides various calibration tools for tuning model variables in the forecasting model 102. A reporting module 116 receives information from the forecasting module 102 to provide various reports to users.

The forecasting model 102 includes a number of modules that perform various functions for the forecasting module 102.

A raw data analysis and aggregation module 118 performs STEP 2 to provide for each matter type statistical analysis of data for each of the six steps. This statistical analysis provides for each step of a particular matter type the following values: mean value and standard deviation for the duration of each step; mean value and standard deviation of added custodians for each step; standard deviation and mean value of added custodians for each step; mean value and standard deviation of added data sources for each step; mean value and standard deviation of added data sources; GB per custodian; GB per data source; and per cent fallout rate for each step.

An existing matter forecasting module 120 performs STEP 3 that extrapolates progress for known existing matters.

A future matter forecasting module 122 performs STEP 4 by forecasting how many new matters are likely to occur over the duration of a forecasting period. The forecasting module 122 also extrapolates the average progress that matters are likely to experience within the forecast period.

A volume production forecasting module 124 performs STEP 5 by extrapolating quantitative characteristics of the material to be collected and calculates expected export volumes.

A cost modeling module 126 performs STEP 6 by using the extrapolated collection volume previously calculated and applying a culling rate and average estimated review cost.

A trend analysis module 128 analyzes historical data to determine if longer term trends occur and if seasonal or cyclical patterns occur.

An event correlation analysis module 130 analyzes patterns of litigation events in order to establish important relationships between the events and to improve accuracy of the forecasts.

An error tracking module 132 for costs compares forecasted cost to actual costs and makes appropriate changes to calibrate the forecasting module with historical data.

Data Gathering and Preparation

A first step is gathering of historical matter data. Historical data for litigation matters typically show a consistent pattern of events that are expected to recur in the future. A forecasting engine uses the following attributes when analyzing historical data for legal matters: trends, cyclical patterns, and irregular patterns. Trends recognize that the number of new legal matters fluctuates from month to month and from quarter to quarter. Historical data gathered over a long period of time may indicate that the number of litigation matters per quarter tends to increase or decrease over time. A cyclical pattern may show a repeating sequence of events that lasts for more than a year. A seasonal pattern in the number of new litigation matter may show, for example, a significant decrease during the summer time or a major holiday and an increase at the beginning of the New Year quarter. This is similar to the cyclical pattern in that it captures a regular pattern of variability in the time series of events within a one year period. An irregular pattern represents random variations triggered by random factors.

Automated Data Collection

An important aspect of cost forecasting is insuring the consistency of the collected data. This is best accomplished by relying on accurate and consistent data collection methods. In order to minimize the possibility of human error and to increase overall reliability, historical data is collected as automatically as possible. The data is also aggregated by matter type to enable more precise cost forecasting.

One implementation of the forecasting method automatically captures and summarizes the following variables: the number of new matters per quarter, the fallout rate of matters, the number of custodians within the scope of each matter, the number of data sources within the scope of each matter, the time duration of the matter, the time duration of the matter in days, the time duration between creation of a matter and the first export event, in days, the size of a data source collection, in gigabytes (GB), and the size of collection per person, in GB. A key principle is to use the most reliable historical data available. In a preferred embodiment, almost all legal matters and all of their collection processes are managed and tracked through a single application that can aggregate all of this information into a single knowledge base. A forecasting engine according to the present invention has access to that knowledge base, and consequently possesses huge amounts of historical data pertaining to the majority of the legal matters in a company. Data captured in this way is highly reliable and accurate, which improve the accuracy of the overall model. Legal matters are typically categorized into various matter types. For example, a legal department may choose to categorize matters into matter types, such as, for example, Employment>>, Securities, Intellectual Property, and Regulatory. Different matter types are characterized by potentially widely dispersed historical data parameters. In order to create more reliable historical data series the historical data for each matter type are automatically captured.

Table 1 is an example of the initial data that can be captured for each matter: This data includes information for an ID number, a matter type, a responsible attorney, an opening date, a billing unit, a case or matter name, the number of custodians of information, the number of gigabytes (GB) collected from the custodians, the number of GB per custodian, the number of data sources, the number of GB collected from the data sources, and the number of GB per data source.

TABLE 1

| | Matter | | | | | | Cus | GB/ | | DS | GB/ |
|---|---|---|---|---|---|---|---|---|---|---|---|
| ID | Type | Atty | Opened | B/U | Name | Cus | GB | cus | DS | GB | DS |
| 04-1234 | Employment | Gentry | Dec. 13, 2004 | Corp | Hanson | 72 | 288 | 4.00 | 5 | 288 | 57.60 |
| | | | | | v. GFC | | | | | | |
| 07-3940 | Employment | Gentry | Jan. 4, 2007 | IB | Holbrook | 88 | 532 | 6.05 | 12 | 532 | 44.33 |
| | | | | | et al | | | | | | |
| 06-2271 | Employment | Harris | Mar. 2, 2006 | IB | Joiner | 6 | 24 | 4.00 | 2 | 24 | 12.00 |
| 06-2272 | Employment | Gentry | Apr. 14, 2006 | Cards | Mortimer | 3 | 40 | 13.33 | 2 | 40 | 20.00 |
| 06-2550 | Employment | Salas | Apr. 14, 2006 | Retail | Peterson | 12 | 48 | 4.00 | 3 | 48 | 16.00 |
| 06-2700 | Employment | Gentry | May 24, 2006 | Cards | Samuels | 14 | 56 | 4.00 | 4 | 56 | 14.00 |
| | | | | | v. GFC | | | | | | |
| 06-3112 | Employment | Gentry | May 28, 2006 | IB | Wilson | 8 | 32 | 4.00 | 1 | 32 | 32.00 |
| | | | | | v GFC | | | | | | |
| S1299 | Securities | Morris | May 21, 2006 | Cards | N1 | 22 | 22 | 1.00 | 3 | 12 | 4.00 |
| S2200 | Securities | Morris | Jan. 23, 2006 | Retail | N2 | 60 | 60 | 1.00 | 4 | 15 | 3.75 |
| S1431 | Securities | Gibbons | Mar. 2, 2006 | IB | N3 | 237 | 237 | 1.00 | 11 | 22 | 2.00 |
| S1700 | Securities | Keller | Jan. 4, 2007 | IB | N4 | 44 | 44 | 1.00 | 3 | 9 | 3.00 |
| S1909 | Securities | Morris | Mar. 2, 2006 | IB | N5 | 19 | 19 | 1.00 | 2 | 5 | 2.50 |
| S1100 | Securities | Keller | Jan. 4, 2007 | IB | N6 | 32 | 32 | 1.00 | 5 | 11 | 2.20 |

The following list is an illustrative example of six different stages that a legal matter can go through:

(1) Notice of potential claim;

(2) Complaint filed and served;

(3) Interrogatories and discovery requests served;

(4) First meet and confer conference;

(5) First production of documents; and

(6) Second document request with collection plan.

TABLE 2 illustrates that those six stages of a matter can be automatically determined based on certain events events, which are captured and used to manage and track all legal matters and their collection in a particular company. Corresponding Atlas events are shown, where Atlas refers to litigation policy and collection management systems provided by PSS Systems of Mountain View, Calif.

TABLE 2

| Matter Stage | Atlas Event |
|---|---|
| Notice of potential claim | One Request for the matter is created |
| Complaint filed and | A document is attached to the matter. |
| served | |
| Interrogatories and | The first collection (notice or plan) is created. |
| discovery requests | This can be either individual collection |
| served | or Bulk collection |
| First meet and confer | The collections are executed. The logs are |
| conference | entered in to Atlas |
| First production of | The first document export has occurred, which |
| documents | means that some documents collected were |
| | sent to culling and review. |
| Second document request | Two requests are created and each one has |
| | at the least one associated collection |
| | (notice or plan) |

Forecasting Model Methodology

An illustrative example of the methodology of the forecasting model is described below. The forecasting model is based on the iterative approach and includes the following steps 1 through 6:

(Step 1) Historical Data Stage Durations

For simplicity, the principles and equations used by the forecasting model are illustrated below with a small number of legal matters. In reality, there is likely to be hundreds, thousands, if not tens of thousands of legal matters.

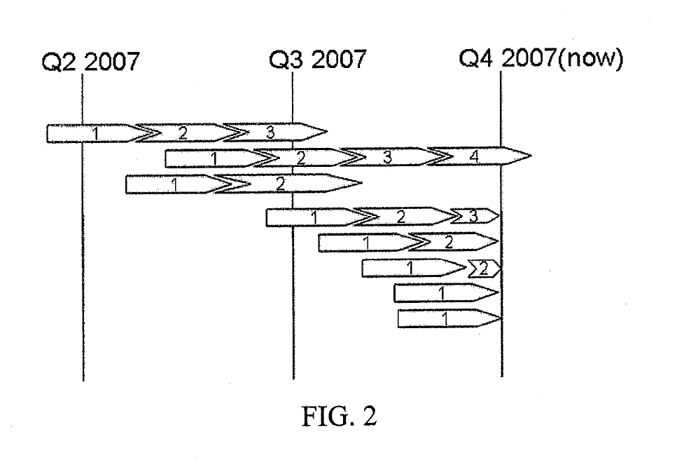

FIG. 2 is a timing chart that show actual historical information for eight existing legal matters 200 through 207 over two past quarters Q2 2007 and Q3 2007 and now at the beginning of Q4 2007. Matters 202 and 202 are closed and the other six matters 201 and 203 through 207 are still active. The time duration of each of the stages of a matter are illustrated as a stage segment having one of the numerals 1 through 6 placed within each stage segment. For example, matter 201 is shown as having progressed through steps 1, 2, 3, and is now in step 4. From there, the first step of the forecasting model method captures the stage transition data which includes the information on the duration of each matter stage and the number of new custodians and data sources added during a given stage.

TABLE 3 shows historical data for each stage of a particular matter. For each stage this historical data includes a matter type, a matter number, a previous stage number, a date of the previous stage, a fallout status indicator, a date for the end of the stage, the time duration of the stage, the number of added custodians, the collected GB per custodian, the added data sources, and the collected GB per data source.

TABLE 3

| Matter | | Prev | Prev | | Fall | | | Add | GB/ | add | GB/ |
|---|---|---|---|---|---|---|---|---|---|---|---|
| Type | Matter | Stage | Date | Stage | out | D | duration | Cust | Cust | DS | DS |
| Empl | 04-1234 | 1 | Dec. 13, 2006 | 2 | 0 | Jan. 13, 2007 | 30 | 100 | 600 | 2 | 600 |
| Empl | 04-1234 | 2 | Jan. 13, 2007 | 3 | 0 | Mar. 6, 2007 | 53 | 5 | 23 | 1 | 23 |
| Empl | 07-3940 | 2 | Dec. 23, 2006 | 3 | 0 | Jun. 4, 2007 | 161 | 40 | 234 | 4 | 234 |
| Empl | 06-2271 | 1 | Jan. 2, 2007 | | 1 | Mar. 2, 2007 | 60 | 111 | 234 | 1 | 1212 |
| Empl | 06-2272 | 3 | Jan. 14, 2007 | 4 | 0 | Apr. 14, 2007 | 90 | 3 | 22 | 1 | 22 |
| Empl | 06-2272 | 3 | Apr. 14, 2007 | 4 | 0 | Aug. 14, 2007 | 51 | 3 | 233 | 1 | 233 |
| Empl | 06-2272 | 4 | Aug. 14, 2007 | 5 | 0 | Dec. 14, 2007 | 66 | 3 | 23 | 1 | 121 |
| Empl | 06-2272 | 5 | Dec. 14, 2007 | 6 | 0 | Jan. 14, 2008 | 30 | 0 | 0 | 0 | 0 |
| Empl | 06-2550 | 2 | Apr. 14, 2007 | | 1 | Aug. 14, 2007 | 120 | 132 | 23 | 2 | 23 |
| Empl | 06-2700 | 4 | May 24, 2007 | | 1 | Sep. 24, 2007 | 64 | 12 | 23 | 1 | 23 |
| Empl | 06-2701 | 4 | Mar. 24, 2007 | 5 | 0 | Aug. 24, 2007 | 24 | 23 | 23 | 4 | 234 |
| Empl | 06-3112 | 5 | Sep. 28, 2007 | 6 | 0 | Dec. 28, 2007 | 90 | 121 | 34 | 2 | 34 |
| Empl | 07-3422 | New | Mar. 1, 2007 | 1 | 0 | Mar. 1, 2007 | 0 | 0 | 0 | 0 | 0 |
| Secur | S1299 | 2 | Mar. 12, 2007 | 3 | 0 | May 21, 2007 | 69 | 20 | 356 | 1 | 356 |
| Secur | S1299 | 1 | Sep. 21, 2007 | 2 | 0 | Jan. 12, 2008 | 111 | 20 | 0 | 3 | 0 |
| Secur | S2200 | 3 | Dec. 23, 2006 | 4 | 0 | Feb. 12, 2007 | 49 | 3 | 23 | 2 | 23 |
| Secur | S2200 | 4 | Dec. 12, 2007 | 5 | 0 | Aug. 3, 2007 | 45 | 3 | 23 | 2 | 23 |
| Secur | S2200 | 5 | Aug. 3, 2007 | 6 | 0 | Dec. 23, 2007 | 36 | 3 | 23 | 2 | 23 |
| Secur | S1431 | 4 | Jan. 2, 2007 | 5 | 0 | Mar. 11, 2007 | 69 | 12 | 23 | 4 | 12 |
| Secur | S1431 | 5 | Mar. 11, 2007 | 6 | 0 | May 3, 2007 | 52 | 0 | 23 | 0 | 3 |
| Secur | S1700 | 1 | Nov. 2, 2007 | 0 | 1 | Jan. 4, 2008 | 62 | 22 | 23 | 2 | 23 |
| Secur | S1909 | 2 | Feb. 2, 2007 | 3 | 0 | Mar. 12, 2007 | 40 | 12 | 323 | 1 | 323 |
| Secur | S3422 | New | Mar. 1, 2007 | 1 | 0 | Mar. 1, 2007 | 0 | 0 | 0 | 0 | 0 |
| Secur | S3423 | New | Apr. 12, 2007 | 1 | 0 | Apr. 12, 2007 | 0 | 0 | 0 | 0 | 0 |
| Secur | S3433 | New | May 12, 2007 | 1 | 0 | May 12, 2007 | 0 | 0 | 0 | 0 | 0 |
| Secur | S3455 | New | May 12, 2007 | 1 | 0 | May 12, 2007 | 0 | 0 | 0 | 0 | 0 |
| Secur | S1100 | 3 | Nov. 14, 2007 | 4 | 0 | Jan. 4, 2008 | 50 | 21 | 233 | 3 | 2 |

(Step 2) Aggregate Captured Stage Transition for Individual Matter

The data captured in stage 1 is statistically analyzed and aggregated by matter type and one of the six stages. TABLE 4 shows that, for each stage of a matter type, the data includes as follows: a matter type, a previous (from) stage and a new stage, mean and standard deviation for the duration of the stage, the means and standard deviation of the number of added custodians, the mean and standard deviation of added data sources, the number of GB per custodian, the GB per data source, and the per cent fallout rate for matter types in that stage.

TABLE 4

| | | | | | | Std. | | Std. | | | |
|---|---|---|---|---|---|---|---|---|---|---|---|
| | | | | Std. | | Dev. | | Dev. | | | Fall |
| Matter | From | To | | Dev | Add | Add | Add | Add | GB/ | GB/ | out |
| Type | Stage | Stage | Duration | Duration | Cust | Cust | DS | DS | Cust | DS | rate % |
| Employ | 1 | 2 | 45.00 | 15.00 | 106 | 6 | 2 | 1 | 417.00 | 906.00 | 86 |
| | 2 | 3 | 111.33 | 44.51 | 59 | 54 | 2 | 1 | 93.33 | 93.33 | 73.3 |
| | 3 | 4 | 70.50 | 19.50 | 3 | 0 | 1 | 0 | 127.50 | 127.50 | 39 |
| | 4 | 5 | 51.33 | 19.34 | 13 | 8 | 2 | 1 | 23.00 | 126.00 | 21 |
| | 5 | 6 | 60.00 | 30.00 | 61 | 61 | 1 | 1 | 17.00 | 17.00 | 0 |
| Security | 1 | 2 | 86.50 | 24.50 | 21 | 1 | 3 | 1 | 11.50 | 11.50 | 92 |
| | 2 | 3 | 54.50 | 14.50 | 16 | 4 | 1 | 0 | 339.50 | 339.50 | 68 |
| | 3 | 4 | 49.50 | 0.50 | 12 | 9 | 3 | 1 | 128.00 | 12.50 | 39 |
| | 4 | 5 | 57.00 | 12.00 | 8 | 5 | 3 | 1 | 23.00 | 17.50 | 21 |
| | 5 | 6 | 44.00 | 8.00 | 2 | 2 | 1 | 1 | 23.00 | 13.00 | 0 |

(Step 3) Extrapolate Progress on Existing Matters

Based on the statistical information produced from steps 1 and 2, progress on known existing matters can be extrapolated. The method uses statistical data produced in the step 2 to calculate probability distributions for reaching a production stage for existing matters. Probability of production is linked to the stage in the life cycle of the matter; and the probability of production tends to increase as a matter advances to later stages. Implementation of the forecasting model for extrapolating progress on existing matters is described below. The forecasting knowledge database contains data describing expected legal matter stage durations and other statistical characteristics grouped by matter types.

The forecasting model uses this information to extrapolate the following: The number of matters to reach the export stage during the forecasting period is based on the current matter stage and stage duration characteristics for a given matter type. For instance, for “Employment” matter types, the duration of the stage 3 averages 120 days with a standard deviation of 14 days, while stage 4 averages 140 days with a standard deviation of 42 days. The model applies these parameters to a matter that just reached stage 3 and using simple probability distribution approach extrapolates the likelihood of reaching the export stage. The number of matters to close before reaching the export stage is obtained by applying the fallout rate probability to the number of matters that are expected to reach the export stage according to their current stage.

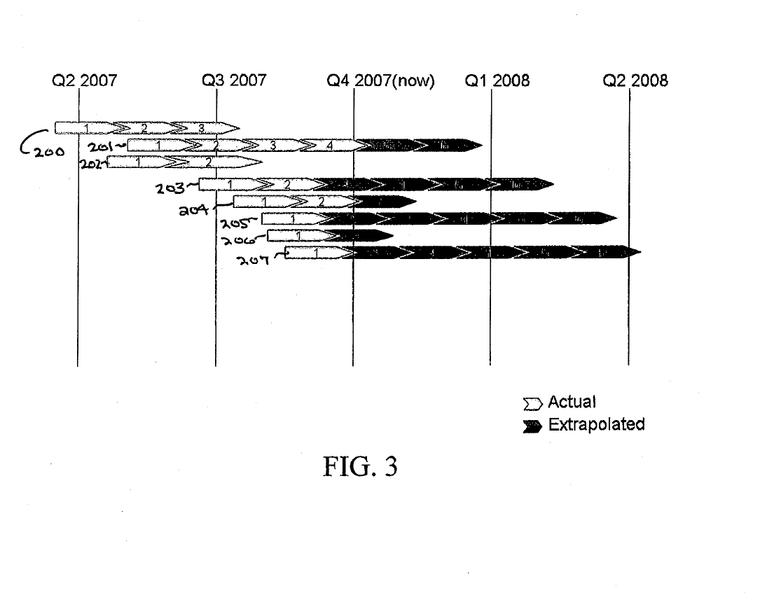

FIG. 3 is an illustrative timing chart extrapolated progress for the six active matters 201, 203 through 207 of FIG. 3 at the beginning of the new quarter Q4 2007. Matter 201 is forecasted as completing stages 5 and 6 in Q4 2007. Matter 203 is forecasted as completing stages 3, 4, 5 in Q4 and stage 6 in Q1 2008. Matter 204 is forecasted as completing stage 3 and terminating in Q5 2007. Matter 205 is forecasted a completing stages 2, 3, 4 in Q4 2007 and 5, 6 in Q1 2008. Matter 206 is forecasted as completing stage 2 in Q4 2007. Matter 207 is forecasted as completing stages 2, 3 in Q4 2007 and stages 4, 5, 6 in Q1 2008.

A triple exponential smoothing forecasting model can be used since it has an advantage over the other time series methods such as single and double exponential smoothing method because it takes into account trend and seasonality in the data. In addition, past observations are given exponentially smaller weights as the observations get older. In other words, recent observations are given relatively more weight in forecasting than the older observations. Also included are a base level Lₜ, a trend Tₜ as well as a seasonality index Sₜ.

Four equations are associated with triple exponential smoothing:
Lₜ=α*(Xₜ/S_{t-c})+(1−α)*(Lₜ₋₁+Tₜ₋₁), where Lₜ is the estimate of the base value at time t and α is the constant, used to smooth Lₜ.
Tₜ=β*(Lₜ−Lₜ₋₁)+(1−β)*Tₜ₋₁, where Tₜ is the estimated trend at time t and β is the constant used to smooth the trend estimates.
Sₜ=χ*(Xₜ/Lₜ)+(1−χ)*S_{t-c}, where Sₜ is the seasonal index at time t, χ is the constant used to smooth the seasonality estimates, and c is the number of periods in the season. For example, c=4 for the quarterly data. ‘And finally the forecast at the time t for the period t+k is Fₜ₊ₖ=(Lₜ+k*Tₜ)*S_{t+k-C}

Initial values for Lₜ, Tₜ, and Sₜ can either be entered into the system or alternatively can be derived from the data. At least 2 cycles of data are required to properly initialize the forecasting model.

(Step 4) Forecasting Future Matters

We can also forecast how many new matters are likely to be created over the duration of the forecasting period. We can also extrapolate the average pace of progress that these matters are likely to go through within the forecast period.

The method uses statistical data produced in the step 2 to calculate probability distribution for creation of the future matters.

The forecasting knowledge base contains data describing expected new matters created for a given matter type within specified time interval.

For instance, for “Employment” matter type there is an average of 3 new matters per quarter created. The trend for the last quarters also indicates a steady grows in number of new matters. Model uses this information to extrapolate the following: Number of new matters created within the forecasting period based on the new matter average, trend and possible seasonal fluctuations. Possible progress on the future matters as described in the step 3. The forecasting model is similar to the model used in Step 3.

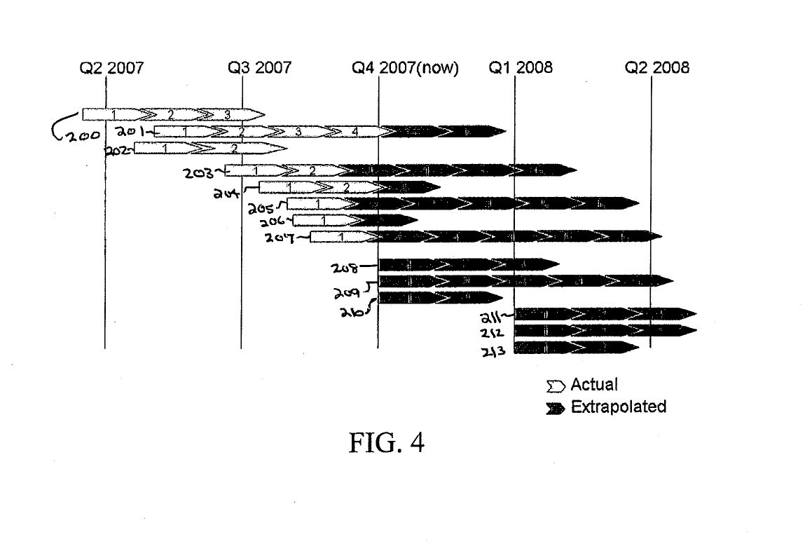

FIG. 4 is another timing chart that shows the active matters in the first two quarters of FIG. 3 and that also shows six forecasted new matters, where three new matters 208, 209, 210 start in the new quarter Q4 2007 and three other new matters 211, 212, 213 start in the next quarter Q1 2008. Matter 208 is expected to terminate after stage 3 in Q1 2008. Matter 209 is expected to go through stages 1, 2, 3, 4, and 5 into Q2 2008. Matter 210 is expected to go through steps 1 and 2 and terminate in Q4 2007. Matters 211 and 212 are expected to go through stages 1, 2, and 3 and on into Q2 2008. Matter 213 is expected to terminate after stage 2 in q1 2008.

(Step 5) Forecasting the Volumes of Production

The number of custodians and data sources in scope has a significant impact on the volume of production. The forecasting model provides a method that extrapolates the quantitative characteristics of the collection scope and that provides calculations of expected export volumes. One embodiment of an implementation estimates volume of production using the following methodology. This includes estimating the number of custodians and data sources that are likely to be involved in collections during the forecasting period by adding up the numbers of persons and data sources that were in the involved in the collection scope in the beginning of the forecasting period and adding those that are likely to be added during the period. The forecasting knowledge base contains information on how many new data sources and persons have been added in the past at each stage of a given matter type. For example, for “Employment” matter types, the average number of new persons added to the collection scope is 31 with standard deviation of 4 (see step 2) above. This embodiment also includes estimating the volume of collections. The forecasting knowledge base contains information on average size of collection for custodians and data sources per stage grouped by matter type. Iteratively applying probability weighted volume averages to the number of custodians and data sources estimated in the previous step the method provides an estimate of the total volume of collections.

(Step 6) Cost Forecast

A future discovery cost is derived from the extrapolated collection volume calculated in the previous step by applying a culling rate and an average review cost. The review costs are typically estimated based on a number of pages produced, culling rate, and review rate measured in dollars per page. One implementation of a method to estimate the discovery cost based on extrapolated collections volume is described below. Collections can contain large numbers of various types of files. The number of pages per gigabyte GB) of data varies dramatically based on the type of file. For instance, a txt file or a MS Excel file may be small in size but would likely result in large number of pages. On the other hand, msg message files may be large in size but usually result in a small number of pages. The method provides a simple mapping that defines average number of pages per GB of collected data for a specified document type using the averages of Table 5.

TABLE 5

| | Average |
|---|---|
| Document Type | Pages/GB |
| Microsoft Word | 65,000 |
| Email | 100,100 |
| Microsoft Excel | 166,000 |
| Lotus 1-2-3 | 290,000 |
| Microsoft PowerPoint | 17,500 |
| Text | 678,000 |
| Image | 15,500 |

For matters where detailed collected data is not known yet, an average blended page count/GB value can be used to convert the estimated data collected volume into a projected page count.

Once a matter reaches the collection stage, the total volume is extrapolated based on current volume and additional expected collection, while the page count equivalent is computed based on real file types that are pro-rated by actual collected volume. Once the number of pages exported has been estimated, the forecasting engine of the forecasting model FE generates estimated cost numbers along with a measure of the forecast accuracy, as described below.

Forecast Accuracy

Forecast accuracy includes both quantity and time accuracy. Both of these are measured and calculated based on predicted and observed forecast data and also based on the quality of the historical data, including size of the time series and variance within the measured parameters. Forecast accuracy is measured and calculated based on the predicted and observed data using the following equation:

$$Accuracy = 1 - \frac{\sum \frac{{A}_{t} - {F}_{t}}{{A}_{t}}}{n} ,$$

where
Aₜ is the actual cost in the interval t
Fₜ is the forecasted costs for the interval t

Model Calibration

The forecasting model is designed to become more accurate over time. This is achieved by providing the ability to compare the forecasted cost to the actual cost and making appropriate provisions and adjustments to calibrate the model and the historical data, as needed. Another approach to improve accuracy is to separate lower quality historical data and matter funnel data from high quality data, and to weight the high quality data more heavily. One example of a method to separate low quality data includes removal of uncharacteristic events and entire legal matters. Another example removal of events from the historical data, such as test production, collection, etc., that were not intended to be a part of the normal business process and that are unlikely to occur frequently.

Enabling a User to Tune the Quality of the Data Directly into the Model

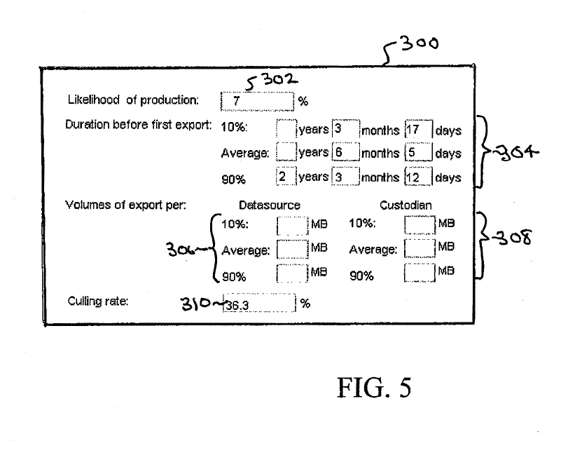

A user can get visibility into some of the forecasting model parameters by modifying the parameters of the forecasting model. FIG. 5 is a data entry screen 300 for a user interface that enables a user to manually adjust major parameters of the forecasting model. Various entry windows are provided for user entry. An entry window 302 is provided a user estimation of likelihood of production actually occurring. A group 304 of entry windows is provided for a user's estimates of the duration of a matter before first export is required. The estimates are in years, months, and days for estimates of 10%, average, and 90%. A group 306 of entry windows is provided for a user's estimates of the volume of export from data sources. These volume estimates are in megabytes (MB) ro4 estimates of 10%, average, and 90%. Another group 306 of entry windows is provided for a user's estimates of the volume of export from custodians. These volume estimates are in megabytes (MB) for estimates of 10%, average, and 90%. An entry window 310 is provided for a user's estimation of culling rate per cent.

Users can also get Visibility into the Forecast Parameters of an Individual Matter

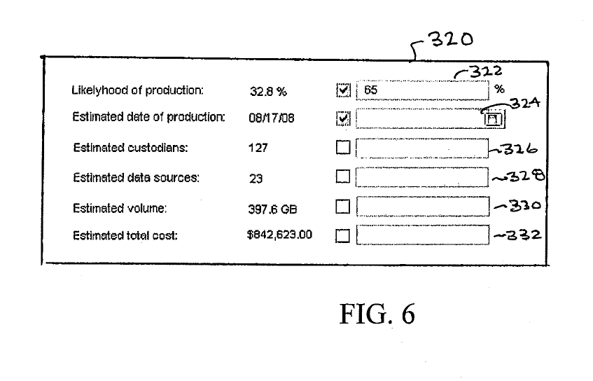

FIG. 6 shows another user data entry screen 320 for a user interface that enables a user to manually adjust parameters of an individual matter by entering values into one or more user entry windows that are selected with corresponding checkboxes. An entry window 322 is selected to modify the percent of likelihood of production. An entry window 324 is selected to modify the estimated date of production. An entry window 326 is selected to modify the number of estimated custodians. An entry window 328 is selected to modify the number of estimated data sources. An entry window 330 is selected to modify the estimated volume in GB. An entry window 332 is selected to modify the estimated total cost. In the Figure, window 322 has been modified with a different percentage and window 324 has been selected for a user to enter another date. The parameters provided by the forecasting model are estimated and a user with enough knowledge can elect to override the estimates with better information to improve forecasting accuracy.

Integration with 3^{rd} Party Systems

Data can also be captured from 3^{rd} party systems such as billing and financial systems used for handling payments to external partners. That data is streamlined into the historical database. This can be used to further increase the accuracy of the cost forecasting by correlating review costs to the event of export and increasing the consistency and integrity of the billing data. A possible implementation of the method to integrate with 3^{rd} party billing system would allow importing the billing and other financial information from outside counsels and review companies information on he regular basis into the forecasting knowledge base. The information is also used for automatic model calibration based on the forecasted costs and actual costs pertaining to discovery billed by 3^{rd} arty vendors.

Important attributes of an effective model for forecasting discovery costs are ease of use, flexibility and data integrity. The forecasting model embodied in the present invention enables a person with little or no training in finance to produce a forecast that he/she is confident in delivering to a company's management team. Because the data used to create the forecast is complete and specific to the company and was collected in a way that minimizes the risk of human error.

Reports

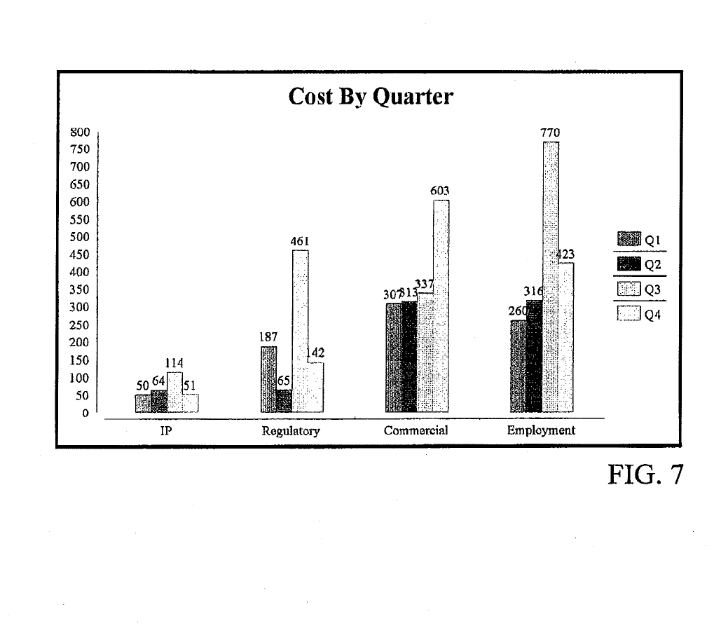

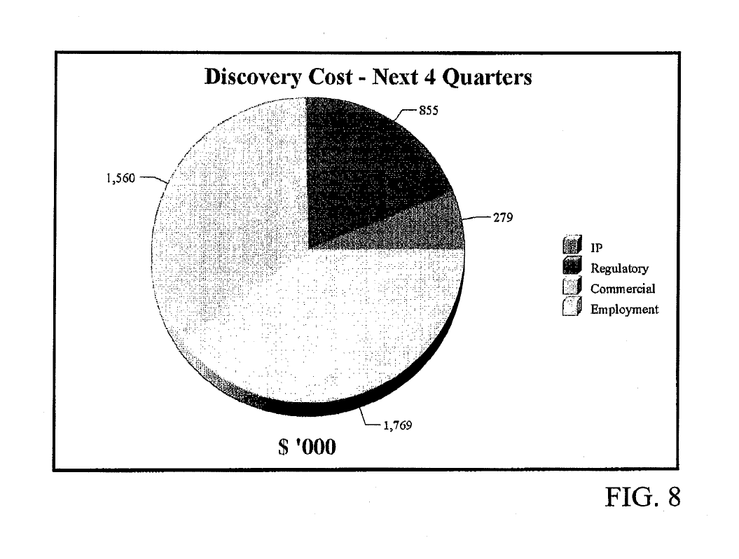

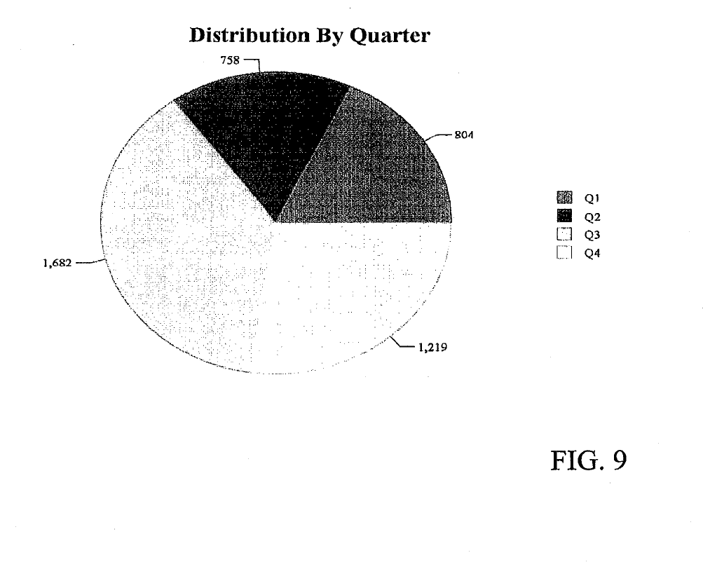

A system according to the present invention automatically collects and analyzes the data identified above and can automatically creates a cost predictability report. If the system accesses all of the data, it can compile the historic data and produce a forecast of cost by quarter. FIG. 7 shows a bar chart reporting the costs for each quarter for each of four different types of matters, such as intellectual property (IP) matters, regulatory matters, commercial matters, and employment matters. FIG. 8 shows a pie chart reporting a yearly estimate of discovery costs for the four different types of matters illustrated in FIG. 7. FIG.8 provides a comparison of the costs for the four types of matters. FIG. 9 is a pie chart illustrating the yearly distribution of quarterly expenses. FIG. 9 provides a comparison of the quarterly costs. Reports can show costs, for example, by matter type, business unit to which costs may be allocated, and responsible attorney.

At any point in time, the forecasting model is able to produce a forecast that looks forward for a specified time period. By looking at changes in the data over time, reports are produced showing changes in the data such as changes in the percentage of matters that move from stage to stage or the average time it takes to progress, improvements in culling rates, increases in review costs, etc.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

We claim:

1. A method of forecasting discovery costs, comprising the steps of:
capturing historic stage transition data for each matter stage, said historic stage transition data including information regarding the duration of each historic matter stage and regarding the number of new custodians and data sources added during that matter stage;
statistically analyzing the stage transition data for each existing matter stage and aggregating existing stage transition data for each matter type;
extrapolating progress for existing matters;
forecasting initiation of future matters by extrapolating how many new matters are expected to be initiated over the duration of a forecasting period;
extrapolating the average pace of progress that the future matters are expected to experience within the forecasting period; and
forecasting the volume of production by extrapolation using quantitative characteristics of said historic stage transition data.

2. A computer implemented method for forecasting litigation discovery costs using historic data for each stage of existing litigation matters, comprising the steps of:
providing historic data for the duration of each stage of existing matters;
calculating historic statistical information from said historic data;
aggregating the historic statistical information by matter type;
calculating probability distributions for reaching production stages for each matter type from the historic statistical information;
extrapolating future progress for each type of existing matter using the historic statistical information;
extrapolating how many new matters will be created using the historical statistical information;
extrapolating an average pace of progresses for each of the new matters during the forecasted future time periods using the historic statistical information; and
forecasting the volumes of production using the number of custodians and data sources.

3. A computer implemented method for forecasting litigation discovery costs using historic data and probability-based forecasting, comprising the steps of:
capturing stage transition data, which includes information on the duration of each matter stage and the number of new custodians and data sources added during a given stage;
analyzing and aggregating by matter type the captured transition data to provide statistical information; and
extrapolating progress on known existing matters using the statistical information; and
forecasting how many new matters are likely to be created over the duration of a forecast period and extrapolating the average pace of progress that matters are likely to go through within the forecast period.

4. The method of claim 3 including forecasting the volumes of production based on the historic data.

5. The method of claim 4 including forecasting discovery costs by applying a culling rate and average review cost.

6. The method of claim 3 wherein the data for each matter stage is analyzed and aggregated by matter type in one or more of the following:
mean duration of the stages,
standard deviation of the duration of the stages
added custodians,
standard deviation of added custodians,
added data sources,
standard deviation of added data sources,
gigabytes collected per custodian,
gigabytes collected per data source, and
fallout rate percent.

7. The method of claim 3 including using statistical data for calculating probability distributions for reaching a production stage for existing matters.

8. The method of claim 3 including extrapolating progress on existing matters.

9. The method of claim 3 including extrapolating with exponential smoothing.

10. A system for forecasting litigation discovery costs using historic data and probability-based forecasting, comprising:
a forecasting data base; and
a forecasting module including a raw data analysis and aggregation module and an existing matter forecasting module.

11. The system of claim 10 including a future matter forecasting module that extrapolates progress for known existing matters.

12. The system of claim 10 including a cost modeling module that uses an extrapolated collection volume along with a culling rate and average estimated review costs.

13. The system of claim 10 including a trend analysis module that analyzes historical data to determine if longer term trends occur and if seasonal or cyclical patterns occur.

14. The system of claim 10 including an event correlation analysis module that analyzes patterns of litigation events.

15. The system of claim 10 including an error tracking module for costs that compares forecasted cost to actual costs and makes appropriate changes to calibrate the forecasting module with historical data.

16. The system of claim 10 including a 3^{rd} party system module that provides to the forecasting model outside information, including matter management information, billing information, and other external data.

17. The system of claim 10 including a model calibration tools module that provides calibration tools for tuning model variables.

18. The system of claim 10 including a reporting module that receives information from the forecasting module and provides reports to users

19. An automated system for forecasting litigation discovery costs using historic data and probability-based forecasting, comprising:
a forecasting data base;
a forecasting module including a raw data analysis and aggregation module and an existing matter forecasting module.;
a litigation database that provides relevant data to an automated data collection module; and
a reporting module that receives information from the forecasting module and provides reports to users.

20. The system of claim 20 including a 3^{rd} party system module that provides to the forecasting model outside information, including matter management information, billing information, and other external data.

21. The system of claim 20 including a model calibration tools module that provides calibration tools for tuning model variables.
